(19) United States
(12) Patent Application Publication
(10) Pub. No.: US 2010/0140978 A1
(43) Pub. Date: Jun. 10, 2010

(54) VEHICLE BODY STRUCTURE AND MANUFACTURING METHOD OF VEHICLE BODY

(75) Inventors: Akinori UTSUNOMIYA, Hiroshima (JP); Chikara TANAKA, Hiroshima (JP); Yoichiro KITAHARA, Hiroshima (JP); Masanori HONDA, Hiroshima (JP); Shin SASAKI, Hiroshima (JP); Takayuki HASHIDA, Hiroshima (JP)

Correspondence Address: Studebaker & Brackett PC, One Fountain Square, 11911 Freedom Drive, Suite 750, Reston, VA, 20190, US

(73) Assignee: MAZDA MOTOR CORPORATION, Hiroshima (JP)

(21) Appl. No.: 12/632,173

(22) Filed: Dec. 7, 2009

(30) Foreign Application Priority Data
Dec. 8, 2008 (JP) 2008-312003
Dec. 8, 2008 (JP) 2008-312004

(51) Int. Cl. B62D 25/08; B23K 26/20

(52) U.S. Cl. 296/193.09; 219/121.64

(57) ABSTRACT

In a vehicle body structure in which a vehicle-body frame of front side frames with a flangeless structure having a rectangular closed cross section and a vehicle-body panel of a dash panel are welded, a concave portion is formed at a specified portion of the vehicle-body panel to which the vehicle-body frame is welded so as to be concaved toward one side which is opposite to a disposition side of the vehicle-body frame and extends in its longitudinal direction, a temporary connection portion which temporarily connects the vehicle-body frame to a side of the concave portion is formed, and a lazar welding portion which connects the vehicle-body frame to the vehicle-body panel is formed near the temporary connection portion so as to extend along the longitudinal direction of the vehicle-body frame.

### BACKGROUND OF THE INVENTION

The present invention relates to a vehicle body structure and a manufacturing method of a vehicle body, in which a hollow vehicle-body frame and a vehicle-body panel are welded.

Conventionally, a vehicle body structure, in which a pair of front side frames is provided at both sides of a front portion of a vehicle body, and each of the front side frames has a slant portion which extends rearward and downward along a dash lower panel and a horizontal portion which is positioned at a rear end portion of the slant portion and extends rearward along a floor panel which forms a bottom of a vehicle compartment, is known as disclosed in Japanese Patent Laid-Open Publication No. 9-254818.

The shape of a cross section of the slant portion and the horizontal portion of the above-described front side frame when viewed in the longitudinal direction is of a U shape having an opening directed toward the side of the dash lower panel and the floor panel. Flanges are formed at both ends of the above-described opening, and these flanges are connected to the dash lower panel and the floor panel, respectively. Meanwhile, a front portion of the above-described front side frame arranged in an engine room has a closed cross section which has flanges at its upper and lower ends, and these flanges are connected to an apron panel or the like.

According to the vehicle body structure disclosed in the above-described publication, the slant portion and the horizontal portion of the front side frame arranged along the dash lower panel and the floor panel have a cross-section shape which is different from that of the front portion of the front side frame arranged in the engine room. Further, the flanges of the slant portion and the horizontal portion are connected to the dash lower panel and the floor panel, and the front portion of the front side frame is connected to the apron panel or the like via the flanges at its upper and lower ends. Accordingly, it may be difficult to form integrally the slant portion and the horizontal portion of the front side frame and the front portion of the front side frame. Therefore, it is generally executed to form separately the slant portion and the horizontal portion of the front side frame and the front portion of the front side frame, and then to weld these portions together.

However, in case the slant portion and the horizontal portion of the front side frame and the front portion of the front side frame are welded together after forming these separately as described above, it may be difficult to ensure the sufficiently-strong connection strength of the members. Therefore, the connection portion may tend to be deformed easily by an impact load which is inputted to the front side frame from a vehicle front body at a vehicle crash. Further, in case the front portion of the front side frame is comprised of a generally-known structure which has a closed-cross section with flanges, in which a pair of members which has a U-shaped cross section and flanges at its both-side ends, and these two members are connected via their flanges, there is a problem in that the connection portion of these flanges would be peeled off due to a torsional load inputted to the front side frame, so that the connection strength would decrease. Thus, a torsional deformation could not be properly prevented from occurring at the above-described apron frame at the frontal or offset crashes of an automotive vehicle and the like.

### SUMMARY OF THE INVENTION

The present invention has been devised based on the above-described problem, and an object to provide a vehicle body structure and a manufacturing method of a vehicle body which can have the superior strength.

According to the present invention, there is provided a vehicle body structure, comprising a flangeless hollow vehicle-body frame which has a rectangular closed cross section, a vehicle-body panel welded to the vehicle-body frame, a temporary connection portion temporarily connecting a face of the vehicle-body frame to the vehicle-body panel, the temporary connection portion comprising a plural connection points which is arranged along a longitudinal direction of the vehicle-body frame, and a lazar welding portion connecting the face of the vehicle-body frame to the vehicle-body panel with a lazar welding, the lazar welding portion comprising a pair of continuous welding rows which is arranged at separate points located near both-side ends of the face of the vehicle-body frame.

According to the present invention, the vehicle body structure having the superior strength, in which the flangeless hollow vehicle-body frame having the rectangular closed cross section and the vehicle-body panel are welded together, can be provided.

According to an embodiment of the present invention, the vehicle-body panel has a concave portion at a central portion thereof between the separate points of the lazar welding portion, the concave portion being concaved toward one side which is opposite to a disposition side of the vehicle-body frame and extending in the longitudinal direction of the vehicle-body frame, and the temporary connection portion is arranged beside the concave portion of the vehicle-body panel. Thereby, the thermal stress which may occur when the vehicle-body panel and the vehicle-body frame are welded can be absorbed at the concave portion properly, so that any improper warp of the vehicle-body panel which may be caused by the thermal stress can be prevented effectively.

According to another embodiment of the present invention, the vehicle-body frame comprises first and second members which have a U-shaped cross section and are connected to each other via a connection end portion thereof, a specified face of the vehicle-body frame which contains one of the connection end portions of the first and second members constitutes the face of the vehicle-body frame to be connected to the vehicle-body panel, and the concave portion of the vehicle-body panel has a size of width which corresponds to the connection end portion of the first and second members. Thereby, the forming of the temporary connection portion and the lazar welding can be properly conducted in the state in which the specified face of the vehicle-body frame containing the connection end portions of the first and second members contacts the vehicle-body panel and the connection end portions are positioned into the concave portion of the vehicle-body panel. Further, the vehicle-body frame, such as a front side frame which extends in a curve shape when viewed from the side of a vehicle, can be easily formed merely by connecting the respective connection end portions of the first and second members. Moreover, the vehicle-body frame, such as the front side frame, and the vehicle-body panel, such as a dash panel arranged at a rear end portion of an engine room, can be connected easily and properly in the state in which they are temporarily connected.

According to another embodiment of the present invention, the temporary connection portion is arranged at both sides of the concave portion. Thereby, since the vehicle-body frame and the vehicle-body panel are temporarily connected so that the temporary connection portion can have its properly-controlled wide distance and the lazar welding portion is formed near this temporary connection portion, the quality of the welding can be improved effectively.

According to another embodiment of the present invention, the first and second members form a front side frame of the vehicle-body frame which extends in a curve shape when viewed from the side of a vehicle. Thus, the front side frame which extends in the curve shape when viewed from the side of the vehicle, can be easily formed merely by connecting the respective connection end portions of the first and second members.

According to another embodiment of the present invention, the temporary connection portion is formed by an ark welding which connects the vehicle-body frame to the vehicle-body panel via small through holes formed at the vehicle-body panel. Thereby, the hollow vehicle-body frame and the vehicle-body panel can be temporarily connected with an ark welding device which is arranged on one side of the vehicle-body panel. Accordingly, even in case it is difficult that a spot welding with a normal spot-welding device is conducted because of a considerably large size of the vehicle-body panel, the vehicle-body panel and the vehicle-body frame can be connected properly, thereby forming the vehicle body having the superior strength easily and properly.

According to another embodiment of the present invention, the temporary connection portion is formed by a one-side spot welding which is applied from one side of the vehicle-body panel. Thereby, the hollow vehicle-body frame and the vehicle-body panel can be temporarily connected with a one-side spot-welding device which is arranged on the side of the vehicle-body panel. Accordingly, even in case it is difficult that the spot welding with the normal spot-welding device is conducted because of the considerably large size of the vehicle-body panel, the vehicle-body panel and the vehicle-body frame can be connected properly, thereby forming the vehicle body having the superior strength easily and properly.

According to another embodiment of the present invention, the concave portion of the vehicle-body panel has a cross section which is of a trapezoid shape. Thereby, in case the thermal stress which may cause deformation of expansion and contraction at the temporary welding or the lazar welding occurs, it can be absorbed effectively at the concave portion, so that any improper warp of the vehicle-body panel which may be caused by the thermal stress can be prevented surely.

According to another embodiment of the present invention, the above-described small through holes are arranged zigzag along the longitudinal direction of the vehicle-body frame. Thereby, the properly-wide disposition distance of the small through holes can be ensured even in case the width of the vehicle-body frame is small. Accordingly, any improper thermal influence which may be caused at the temporary connection of the vehicle-body frame to the vehicle-body panel can be effectively prevented from acting on the temporary connection portion via the small through holes, thereby providing the proper temporary connection of the members.

According to another embodiment of the present invention, the vehicle-body panel is a dash upper panel which is provided at a rear end portion of an engine room, and the vehicle-body frame is a dash cross member which is provided along the dash upper panel so as to extend in a vehicle width direction. Thereby, the hollow vehicle-body frame and the vehicle-body panel can be welded with a lazar-welding device which is arranged in front of the dash panel. Accordingly, even in case it is difficult that the spot welding with the spot-welding device is conducted because of the considerably large size of the vehicle-body panel, the dash panel and the dash cross member can be connected properly, thereby forming the vehicle body having the superior strength easily and properly.

According to another aspect of the present invention, there is provided a manufacturing method of a vehicle body which includes a flangeless hollow vehicle-body frame which has a rectangular closed cross section and a vehicle-body panel which is welded to the vehicle-body frame, comprising a step of forming plural small through holes at a welded portion of the vehicle-body panel to the vehicle-body frame along a longitudinal direction of the vehicle-body frame, a step of temporarily connecting the vehicle-body frame to the vehicle-body panel via the small through holes, and a step of connecting the vehicle-body frame to the vehicle-body panel with a lazar welding which is applied to a specified portion along the small through holes formed in said small-through-hole forming step. This aspect of the present invention can provide substantially the same functions and advantages as those of the above-described invention of the vehicle body structure.

Other features, aspects, and advantages of the present invention will become apparent from the following description which refers to the accompanying drawings.

### BRIEF DESCRIPTION OF THE DRAWINGS

FIG. 1 is a perspective view showing a first embodiment of a vehicle body structure according to the present invention.

FIG. 2 is an explanatory elevation view of a dash panel.

FIG. 3 is a sectional view taken along line III-III of FIG. 2.

FIG. 4 is an exploded diagram showing a specific structure of a front side frame.

FIG. 5 is a sectional view taken along line V-V of FIG. 3.

FIG. 6 is a perspective view showing a connection state of the dash panel and the front side frame.

FIG. 7 is an explanatory elevation view of the dash panel.

FIG. 8 is a sectional view showing an attachment state of a dash cross member.

FIG. 9 is a sectional view showing a comparative example of the present invention.

FIG. 10 is a sectional view showing an operation of the present invention.

FIG. 11 is a sectional view taken along line XI-XI of FIG. 2.

FIG. 12 is a perspective view showing a second embodiment of a vehicle body structure according to the present invention, which corresponds to FIG. 6.

FIG. 13 is a sectional view showing a connection step of the dash panel and the front side frame.

### DETAILED DESCRIPTION OF THE INVENTION

Hereinafter, preferred embodiments of the present invention will be described referring to the accompanying drawings.

### Embodiment 1

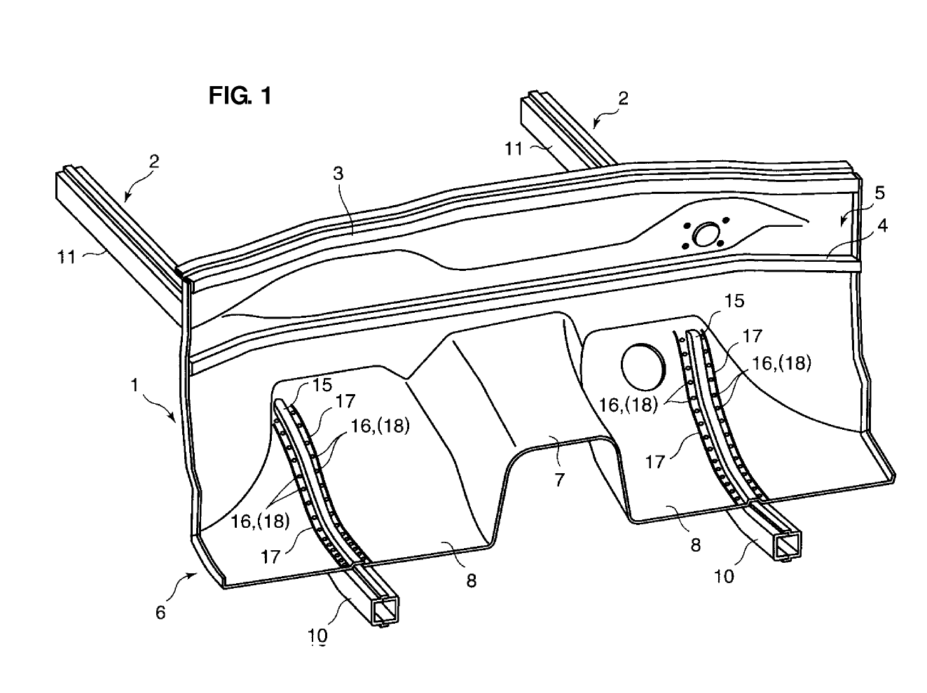

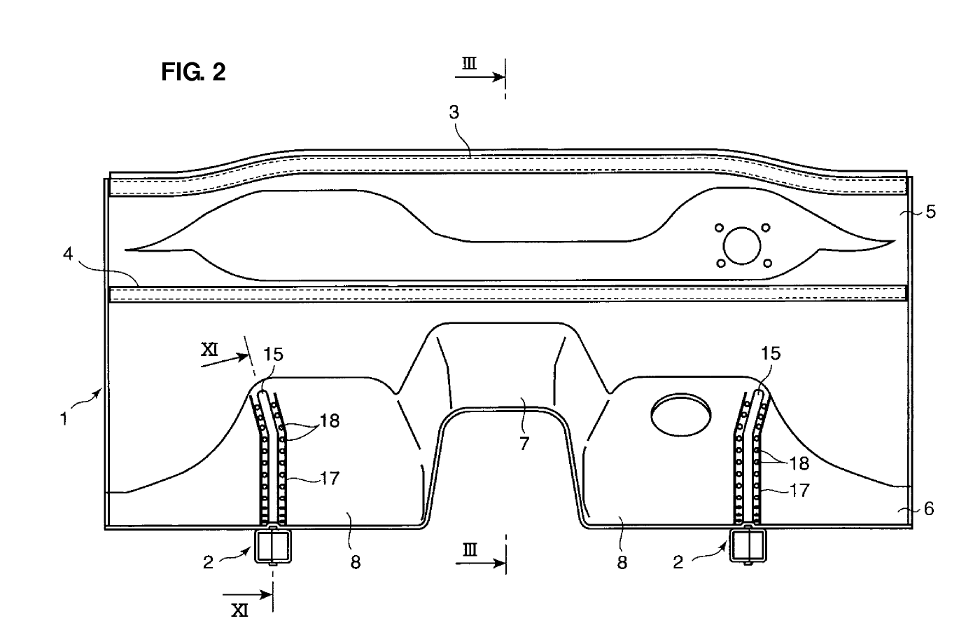

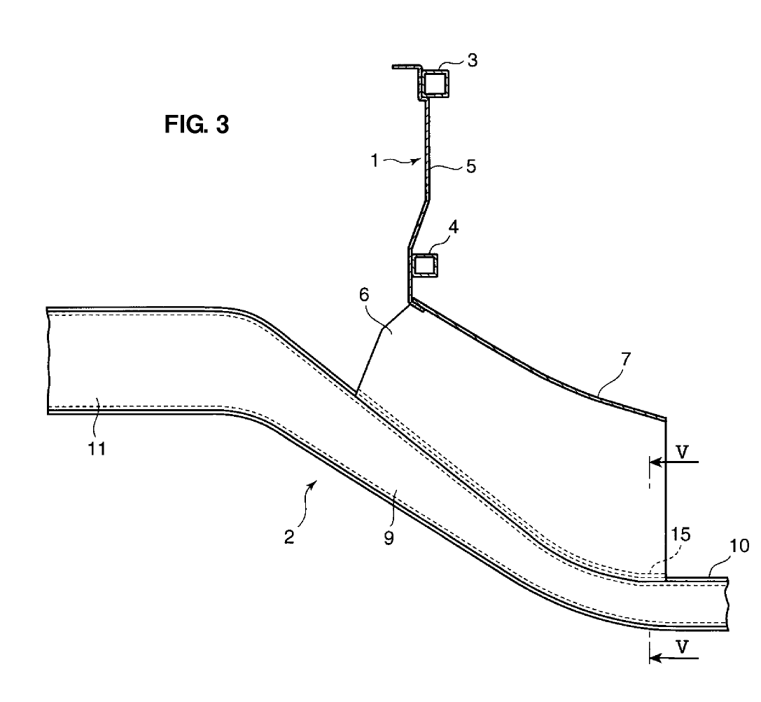

FIGS. 1 through 3 show a first embodiment of a vehicle body structure according to the present invention. This vehicle body structure comprises a vehicle-body panel of a dash panel 1 which partitions a vehicle compartment from an engine room and a vehicle-body frame of a pair of front side frames 2 which extends forward from both sides of the dash panel 1. An upper dash cross member 3 and a lower dash cross member 4 which is located below the upper dash cross member 1 are arranged on an inside wall face, i.e., a back face of the dash panel 1 so as to extend in a vehicle width direction, respectively.

The dash panel 1 comprises a dash upper panel 5 which extends in the vehicle width direction along a cowl box, not illustrated, and a dash lower panel 6 which extends downward from a lower end of the dash upper panel 5. A floor panel (not illustrated) which forms a bottom face of the vehicle compartment is provided in such a manner that its front end connects to a lower end of the dash lower panel 6. A tunnel portion 7 which projects upward is formed at the center of a lower portion of the dash lower panel 6, and a kick-up portion 8 which rises obliquely is formed on the both sides of tunnel portion 7. The above-described front side frames 2 are connected to each lower face of the kick-up portion 8.

Each of the front side frames 2 comprises a slant portion 9, a horizontal portion 10, and a front portion 11. The slant portion 9 extends forward and upward along the kick-up portion 8 formed at the lower portion of the dash lower panel 6 and then forward off the dash panel 1. The horizontal portion 10 extends rearward substantially horizontally from a rear end of the slant portion 9. The front portion 11 extends forward from a front end of the slant portion 9. Thus, the front side frame 2 extends in a curve shape in a side view.

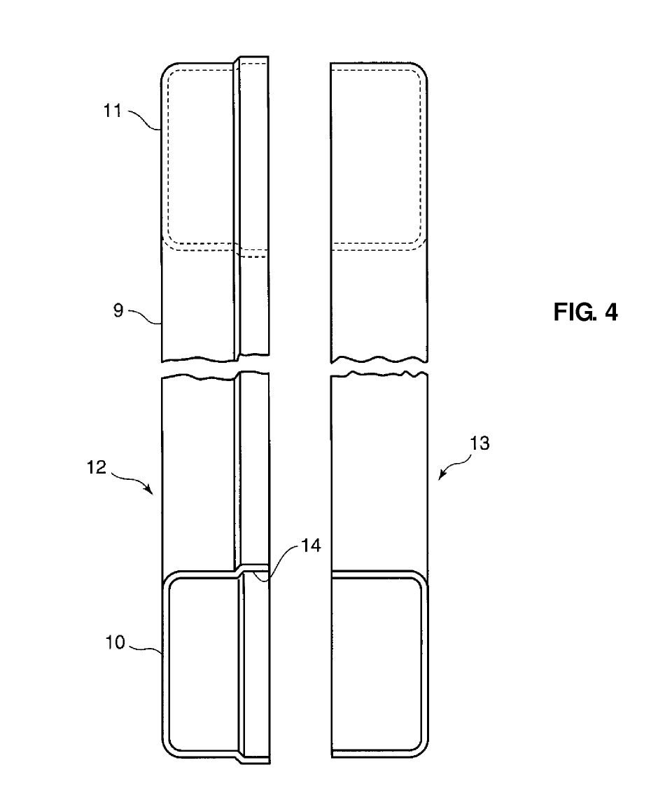

The front side frame 2 is comprised of a flangeless hollow member having a rectangular closed cross section, which is made of a pair of metal first and second members 12, 13 which have a U-shaped cross section made by a press process and are connected to each other, for example, as shown in FIG. 4. The first member 12 which is positioned on the outside has a pair of step portions 14 which projects outwardly at its upper wall end and its lower wall end. Herein, the second member 13 is coupled to the first member 12 in such a manner that an upper wall end and a lower wall end of the second member 13 slide along respective inner faces of the step portions 14. A lazar welding is applied to these overlapped coupling portions to connect the first and second members 12, 13, so that the front side frame 2 with the slant portion 9, the horizontal portion 10, and the front portion 11 can be formed.

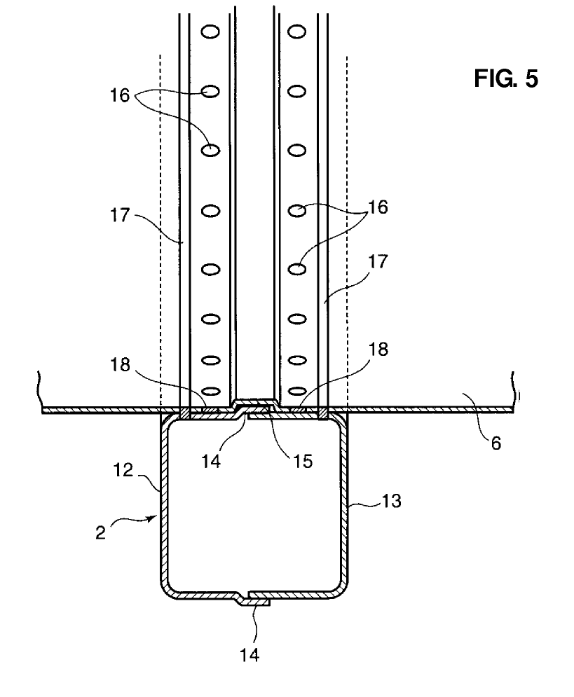

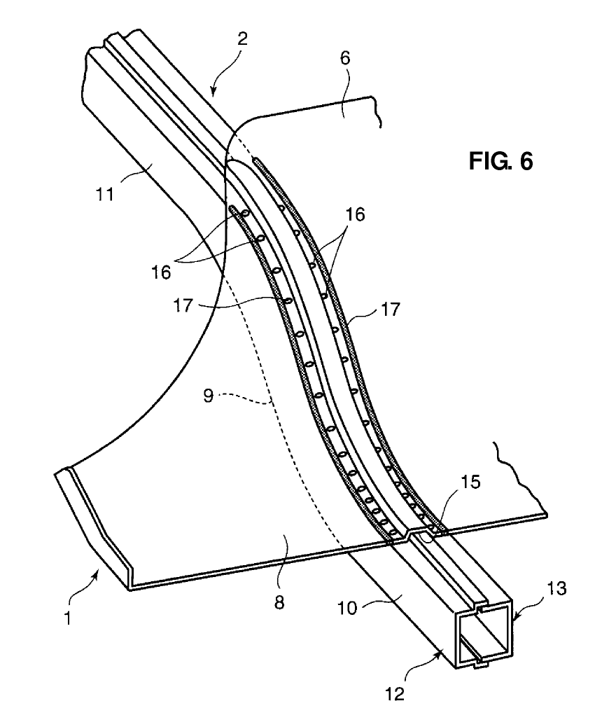

A concave portion 15 is formed at the kick-up portion 8 of the dash lower portion 6 to which the slant portion 9 and the horizontal portion 10 of the front side frame 2 are welded as shown in FIGS. 5 and 6. Herein, the concave portion 15 is formed so as to be concaved upwardly, i.e., toward one side which is opposite to a disposition side of the front side frame 2, and to extend in the longitudinal direction of the front side frame 2, i.e., the disposition direction of the above-described slant portion 9. At both sides of the concave portion 15 is arranged a temporary connection portion 16 which temporarily connects the slant portion 9 and the horizontal portion 10 of the front side frame 2.

Further, near the above-described temporary connection portion 16 is arranged a lazar welding portion 17 which connects the dash lower panel 6 and the front side frame 2. Its welding rows extend in the longitudinal direction of the front side frame 2. This lazar welding portion 17 is formed in such a manner that the lazar beams is irradiated to a specified portion of the panel 6 to be welded and this specified portion is molten by the energy of the lazar beams irradiated. Further, the above-described lazar welding portion 17 may be formed by using a wire lazar-welding device which feeds a wire to the above-described specified portion to be welded to support the welding with this molten wire.

The concave portion 15 of the dash lower panel 6 has the cross section which is of a trapezoid shape and the size of width which corresponds to the connection end portion of the step portion 14 of the first and second members 12, 13. Specifically, the width and the depth of the concave portion 15 are set to be slightly greater than the width and the height of the above-described connection end portion of the front side frame 2. Herein, in a state in which the connection end portion (step portion 14) of the first and second members 12, 13 of the front side frame 2 is positioned into the concave portion 15 of the dash lower panel 6 of the dash panel 1, the temporary connection portion 16 is formed in a below-described manner. After this, the above-described lazar welding portion 17 is formed. Thereby, the front side frame 2 is connected to the lower face of the kick-up portion 8.

That is, plural small through holes 18 which have the diameter of about 5 mm are formed at regular intervals on the both sides of the concave portion 15 of the kick-up portion 8 of the dash lower panel 6. The peripheral portion equipped with these small through holes 18 is temporarily connected to the connection face of the front side frame 2, specifically, to the upper face of the above-described slant portion 9 and horizontal portion 10 which contains the connection end portion of the above-described step portion 14 by the ark welding. Thus, the temporary connection portion 16 which temporarily connects the dash panel 1 and the front side frame 2 is configured to form two connection rows which are arranged along the longitudinal direction of the front side frame 2.

Herein, the disposition distance of these two rows of small through holes 18 is set to be a specified value or greater so that an improperly large gap, for example, 0 5mm or greater, can be prevented from occurring between the slant portion 9 of the front side frame 2 and the kick-up portion 8 of the dash lower panel 6, which may be caused by the warp of the dash lower panel 6 due to the thermal influence by the temporary connection of the dash lower panel 1 and the front side frame 2 with the ark welding. Meanwhile, the disposition distance of these two rows of small through holes 18 is set to be another specified value or smaller so that the gap between the slant portion 9 of the front side frame 2 and the kick-up portion 8 of the dash lower panel 6 can be prevented from increasing due to the thermal influence by the lazar welding.

Then, the lazar welding is applied to the specified portions of the kick-up portion 8 of the dash lower panel 6 near the both-side ends of the front side frame 2 along the disposition points of the small through holes 18 which form the temporary connection portion 16. Thereby, two rows of lazar welding portion 17 which connects the first and second members 12, 13 of the front side frame 2 to the kick-up portion 8 of the front side frame 2 are formed on the outside of the temporary connection portion 16, i.e., at the position located on a side which is opposite to a disposition side of the concave portion 15.

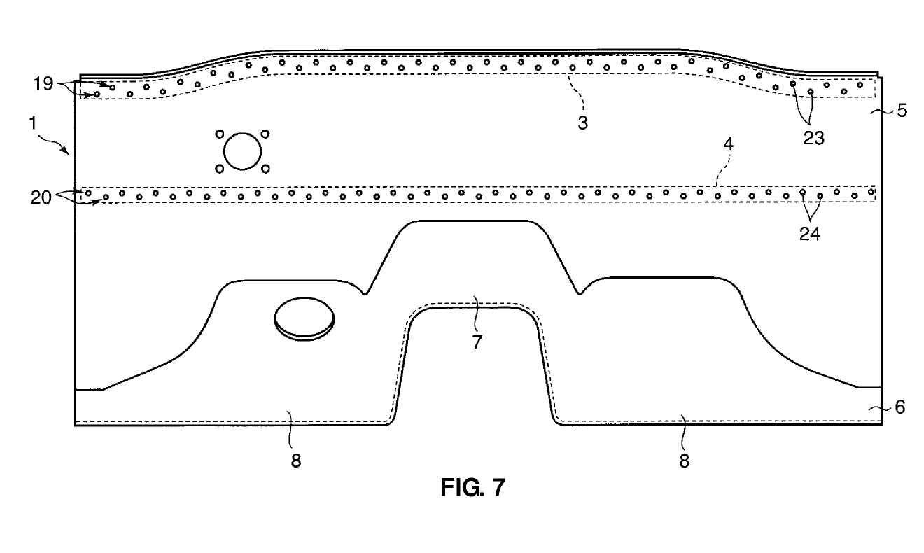

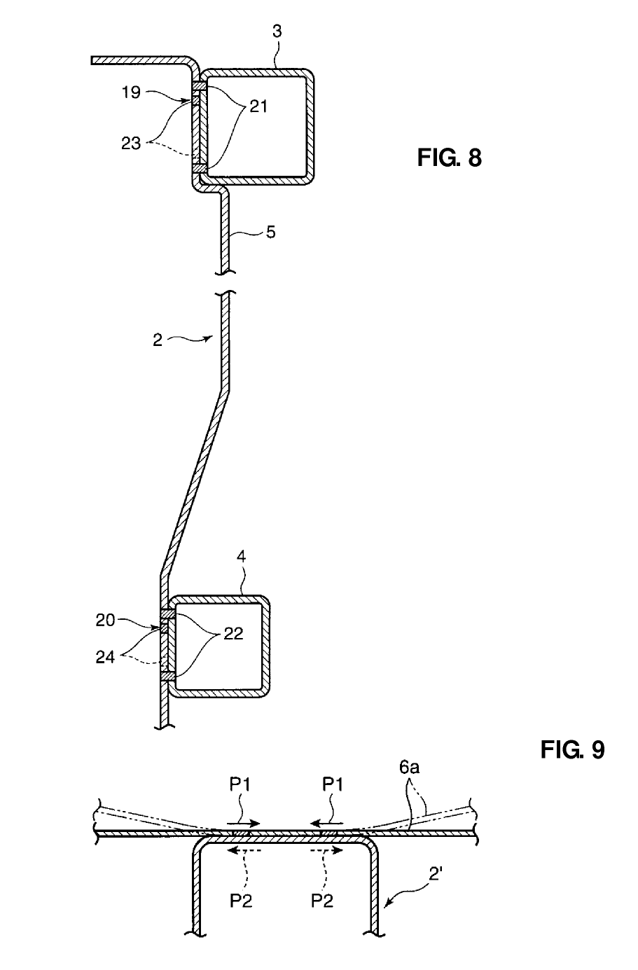

As shown in FIGS. 7 and 8, the upper dash cross member 3 and the lower dash cross member 4 which are welded to the dash upper panel 5 as the vehicle-body frame are formed as a hollow member respectively which is made of a flangeless square pipe or the like having a closed cross section. The dash upper panel 5 has temporary portions 19, 20 to which the upper and lower dash cross member 3, 4 are temporarily connected. Further, lazar welding portions 21, 22 which connect the dash upper panel 5 and the upper and lower dash cross members 3, 4 are formed near the temporary connection portions 19, 20 with their welding rows extending along the longitudinal directions of these cross members.

Thus, many small through holes 23 with the diameter of 5mm are formed at an upper side portion of the dash upper panel 5 along the longitudinal direction of the upper dash cross member 3 at regular intervals. Herein, these small holes 23 are formed zigzag so as to have two welding rows of an upper row and a lower row. A temporary connection portion 19 which temporarily connects the upper dash cross member 3 to the back face of the upper side portion of the dash upper panel 5 via the small through holes 23 is formed by applying the ark welding to this area. Meanwhile, the two rows of lazar welding portions 21 which connect the upper dash cross member 3 to the upper side portion of the dash upper panel 5 are formed at positions located on the both sides of the temporary connection portion 19, i.e., above and below the temporary connection portion 19, along the longitudinal direction by applying the lazar welding to these areas.

Likewise, many small through holes 24 are formed at a lower portion of the dash upper panel 5 along the longitudinal direction of the lower dash cross member 4 at regular intervals. Herein, these small holes 24 are formed zigzag so as to have two welding rows. A temporary connection portion 20 which temporarily connects the lower dash cross member 4 to the lower portion of the dash upper panel 5 via the small through holes 24 is formed by applying the ark welding to this area. Meanwhile, the two rows of lazar welding portions 22 which connect the lower dash cross member 4 to the lower portion of the dash upper panel 5 are formed at positions located on the both sides of the temporary connection portion 20 along the longitudinal direction by applying the lazar welding to these areas.

In manufacturing the front vehicle body, as shown in FIGS. 5 and 6, the hollow front side frame 2 with the flangeless structure having the closed cross section is formed by connecting the respective end portions of the first and second members 12, 13. Further, the plural small through holes 18 are formed at the portion of the dash panel 1 to which the front side frame 2 is welded, i.e., on the both sides of the dash lower panel 6, along the disposition direction of the front side frame 2 at regular intervals. Moreover, the plural small through holes 23, 24 are formed at the upper side portion and the lower portion of the dash panel 1 along the disposition direction of the upper and lower dash cross members 3, 4 at regular intervals.

Then, as shown in FIGS. 7 and 8, in the state in which the square-pipe upper and lower dash cross members 3, 4 are located contacting the back face of the dash upper panel 5 at the position corresponding to the small through holes 23, 24, the ark welding is applied from the front side of the dash panel 1 such that the holes 23, 24 are filled with the molten metal generated by the ark welding. Thereby, the dash upper panel 5 and the upper and lower dash cross members 3, 4 are temporarily connected via the small through holes 23, 24. Further, as shown in FIGS. 5 and 6, in the state in which the connection end portions of the first and second members 12, 13 are positioned into the concave portion 15 of the dash lower panel 6 and the upper face of the slant portion 9 of the front side frames 2 is positioned at the disposition portion of the small holes 18 of the dash lower panel 6, the ark welding is applied from the upper rear side of the dash lower panel 6 such that the holes 18 are filled with the molten metal generated by the ark welding. Thereby, the dash lower panel 6 and the front side frames 2 are temporarily connected via the small through holes 18.

After the vehicle body comprising the dash panel 1, front side frames 2, upper and lower dash cross members 3, 4, so on are temporarily assembled as described above, it is conveyed to a lazar welding section where the lazar-welding device is arranged. In this section, the portions near the both sides of each of the front side frames 2 are welded to the dash panel 1 by applying the lazar welding from the upper rear side of the dash lower panel 6 along the disposition position of the small through holes 18. Further, the portions near the upper and lower sides of each of the upper and lower dash cross members 3, 4 are welded to the dash panel 1 by applying the lazar welding from the front side of the dash upper panel 5 along the disposition position of the small through holes 23, 24.

As described above, in the vehicle body structure in which the vehicle-body frame of a pair of hollow front side frames 2 with the flangeless structure having the rectangular closed cross section and the vehicle-body panel of the dash panel 1 are welded, the concave portion 15 is formed at the specified portion of the dash panel 1 to which each of the front side frames 2 is welded so as to be concaved toward one side which is opposite to the disposition side of the front side frame 2 and extends in the longitudinal direction of the front side frame 2, the temporary connection portion 16 which temporarily connects the fronts side frame 2 to the portion of the dash panel 1 which corresponds to the concave portion 15, and the lazar welding portion 17 which connects the front side frame 2 to the dash panel 1 with the lazar welding is formed near the temporary connection portion 16 so as to extend along the longitudinal direction of the front side frame 2. Accordingly, the vehicle body structure having the superior strength can be provided easily and properly.

That is, according to the present embodiment, the front side frame 2 with the closed cross section has the slant portion 9, the horizontal portion 10, and the front portion 11 which are integrally formed so as to extend continuously in the curve shape when viewed from the side the vehicle by connecting the respective end portions of the first and second members 12, 13 which have the U-shaped cross section. Accordingly, the impact load can be properly transmitted toward the rear portion of the vehicle body and thereby supported effectively, without providing any improper deformation caused by the impact load, which may be generated in the conventional structure in which the slant portion 9, the horizontal portion 10, and the front portion 11 are previously formed separately and then they are connected together.

Further, according to the above-described structure, the strength against the torsional load acting on the front side frame 2 can be improved effectively and thereby the torsional deformation of the front side frame 2 can be restrained effectively, without providing any problem of the conventional structure in that the connection portion of the connection flanges of the front side frame may be peeled off due to the torsional load inputted to the front side frame and thereby the strength may decrease.

Further, the concave portion 15 is formed at the specified portion of the dash panel 1 to which the front side frame 2 is welded so as to be concaved toward one side opposite to the disposition side of the front side frame 2 (i.e., upward) and extend along the longitudinal direction of the front side frame 2, and the lazar welding portion 17 is formed in the state in which the front side frame 2 is temporarily connected to the dash panel 1. Accordingly, even in case it is difficult that the spot welding with a normal spot-welding device is conducted, the front side frame 2 and the dash panel 1 can be connected easily and firmly with the lazar-welding device which may be arranged on one side of the dash panel 1.

Moreover, when the peripheral portion of the dash panel 1 with the small through holes 18 is temporarily connected to the upper face of the front side frame 2 by the ark welding or the dash panel 1 and the front side frame are connected by the lazar welding which is applied near the temporary connection portion 16 along the longitudinal direction of the front side frame 2, any difference in the thermal influence can be prevented from occurring between these members and thereby any improper warp can be properly prevented from occurring at the dash panel 1.

For example, when the peripheral portion of the dash lower panel 6 with the small through holes 18 are connected to the upper face of the front side frame 2 by the ark welding, the heat is generated. This generated heat increases the temperature of the dash lower panel 6 to be higher than that of the front side frame 2, so that the dash lower panel 6 is made expand. Herein, after the both members are temporarily connected in this state, these members are cooled down to the room temperature. In this case, a greater contraction force acts on the dash lower panel 6 than the one acting on the front side frame 2. Accordingly, in case the above-described concave portion 15 is not formed at a dash lower panel 6′ as shown in FIG. 9, after the temporary ark welding, the dash lower panel 6′ may have a warp deformation off a front side frame 2′ as shown by a two-dotted broken line in this figure, which is caused by a thermal stress P1 acting in the direction of contraction of the dash lower panel 6′ and a stress P2 which occurs at the front side frame 2′ against the thermal heat Pl. Thereby, a rather large gap may be inevitably generated between the dash lower panel 6′ and the front side frame 2′.

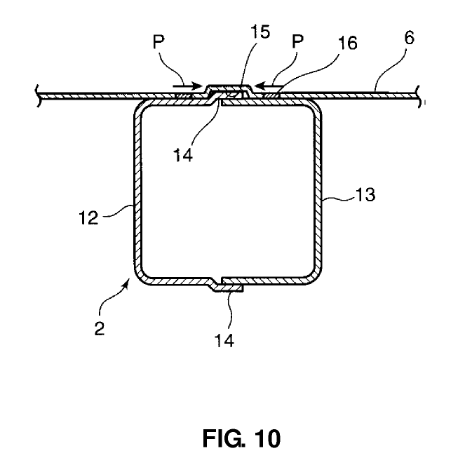

In contrast, in case the concave portion 15 is formed at the welding portion of the dash panel 1 to which the front side frame 2 is welded as shown in FIG. 10, when a thermal stress P to make the dash lower panel 6 contract largely than the front side frame 2 acts according to the temperature decrease after the temporary ark welding, the above-described concave portion 15 can have a resilient deformation to absorb the above-described thermal stress P. Accordingly, it can be prevented that the large stress to cause the improper warp to the dash lower panel 6 is generated, so that the dash lower panel 6 can be effectively restrained from being peeled off the front side frame 2.

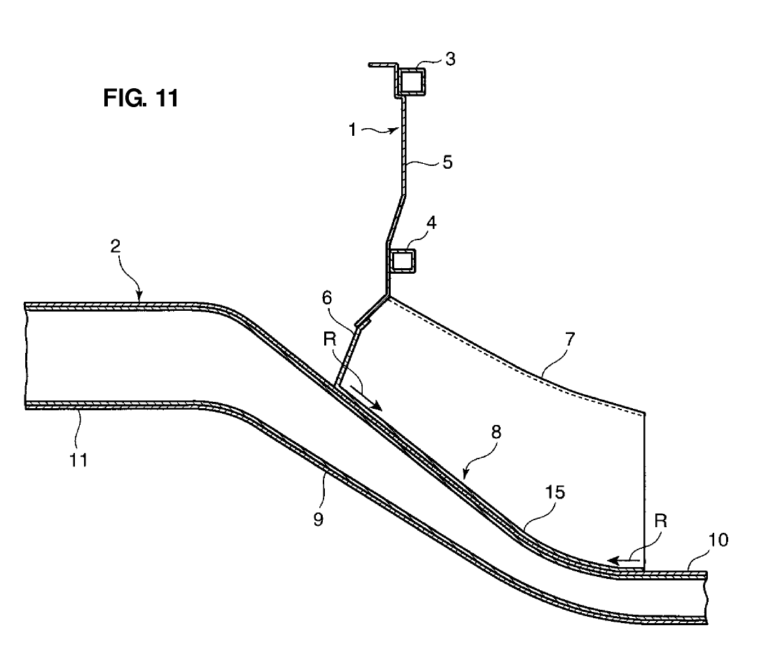

Further, when the dash lower panel 6 and the front side frame 2 are connected by the lazar welding, the heat is generated. This generated heat increases the temperature of the dash lower panel 6 to be higher than that of the front side frame 2. Herein, after the both members are welded in this state, these members are cooled down. In this case, a thermal stress to make the dash lower panel 6 contract largely than the front side frame 2, that is, a thermal stress R to cause the warp deformation to front and rear portions of the kick-up portion 8 of the dash lower panel 6 acts as shown in the side view of FIG. 11. However, the concave portion 15 formed at the dash panel 1 functions as a reinforcing member against the above-described thermal stress R, so that the above-described warp due to the thermal stress R can be prevented from occurring effectively.

Moreover, according to the present embodiment, the lazar welding portion 17 is arranged on the outside of the temporary connection portion 16 provided along the concave portion 15 of the dash lower panel 6. Accordingly, the lazar welding portion can be formed properly in the state in which the gap between the dash lower panel 6 and the front side frame 2 is prevented from being 0.5mm or greater, for example. Thereby, despite the fronts die frame 2 with the flangeless structure having the closed cross section, the quality of the lazar welding is ensured properly so that the vehicle body having the superior strength can be formed easily.

Further, the vehicle-body frame of the front side frame 2 is formed by the first and second members 12, 13 which have the U-shaped cross section and are connected to each other via the connection end portion, the specified face containing the step portion 14 of the first member 12 and the like constitutes the face of the front side frame 2 to be connected to the vehicle-body panel, and the concave portion 15 have the size of width which corresponds to the connection end portion of the first and second members 12, 13. Thereby, the forming of the temporary connection portion 16 and the lazar welding portion 17 can be properly conducted by using the ark-welding device and the lazar-welding device which are arranged on one side of the vehicle-body panel of the dash panel 1 in the state in which the above-described specified face contacts the dash panel 1 and the above-described connection end portions are positioned into the concave portion 15.

Further, the front side frame 2 which has the slant portion 9, the horizontal portion 10, and the front portion 11 and extends in the curve shape when viewed from the side of the vehicle can be formed easily merely by connecting the respective connection end portions of the first and second members 12, 13. Moreover, the front side frame 2 and the dash panel 1 which is arranged at the rear end portion of the engine room can be connected easily and properly by forming the lazar welding portion 17 with the lazar welding in the state in which they are temporarily connected via the above-described small through holes 18.

Moreover, according to the present embodiment, the temporary connection portion 16 is arranged on the both sides of the concave portion 15. Thereby, since the vehicle-body frame of the front side frame 2 and the vehicle-body panel of the dash panel 1 are temporarily connected in the state in which the temporary connection portion 16 has its properly-controlled wide distance between its two rows, the gap between the front side frame 2 and the dash panel 1 can be managed properly. Then, the lazar welding portion 17 is formed near this temporary connection portion, so that the quality of the welding can be improved effectively.

Additionally, the thermal strain which occurs when the temporary connection portion 16 is formed, that is, when the peripheral portion of the dash panel 1 with the small through holes 18 is connected to the front side frame 2 by the ark welding is absorbed by the above-described concave portion 15. Thereby, the two rows of the temporary connection portion 16 can be located close to each other, and the flexibility of layout of the temporary connection portion 16 can be improved effectively.

Further, according to the present embodiment, the above-described temporary connection portion 16 is formed by the ark welding which connects the dash panel 1 and the front side frame 2 via the small through holes 18 which are formed at the vehicle-body panel of the dash panel 1 which is arranged at the rear end portion of the engine room. Thereby, the hollow vehicle-body frame of the front side frame 2 and the dash panel 1 can be temporarily connected with the ark-welding device which is arranged on one side of the dash panel 1. Accordingly, even in case it is difficult that a spot welding with the normal spot-welding device is conducted because of a considerably large size of the dash panel 1, the dash panel 1 and the front side frame 2 can be connected properly, thereby forming the vehicle body having the superior strength easily and properly.

Moreover, according to the present embodiment, the front side frame 2 and the dash panel 1 are connected by applying the lazar welding to the vehicle-body panel of the dash panel 1 at the portion near the both side portions of the front side frame 2. Thus, the lazar welding portion 17 can be formed with the proper width distance between its two rows, so that the front side frame 2 can be connected to the dash panel 1 firmly. Accordingly, even if the torsional load acts on the front side frame 2, the lazar welding portion 17 can be prevented from being peeled off effectively. Further, the thermal influence which occurs when one of the rows of the lazar welding portion 17 is formed can be restrained from acting on the other row of the lazar welding portion 17.

Further, according to the present embodiment, as shown in FIG. 10 and others, the concave portion 15 of the vehicle-body panel of the dash panel 1 has the cross section which is of the trapezoid shape. Thereby, in case the thermal stress P which may cause deformation of expansion and contraction at the temporary welding or the lazar welding occurs, it can be absorbed effectively at the concave portion 15. Accordingly, the vehicle-body panel can be surely restrained from being peeled off the vehicle-body frame due to the above-described thermal stress P.

Herein, while the above-described embodiment shows the example in which the front side frame 2 is comprised of the slant portion 9, the horizontal portion 10, and the front portion 11 which are formed integrally, the present invention is applicable to a case in which the slant portion 9, the horizontal portion 10, and the front portion 11 may be formed separately and then they are welded together. Further, while the above-described embodiment shows the example in which the peripheral portion of the vehicle-body panel with the small through holes 18 is temporarily connected to the welding face of the vehicle-body frame by means of the ark welding, any other connecting means, such as gas welding or brazing, may be used instead of the ark welding.

### Embodiment 2

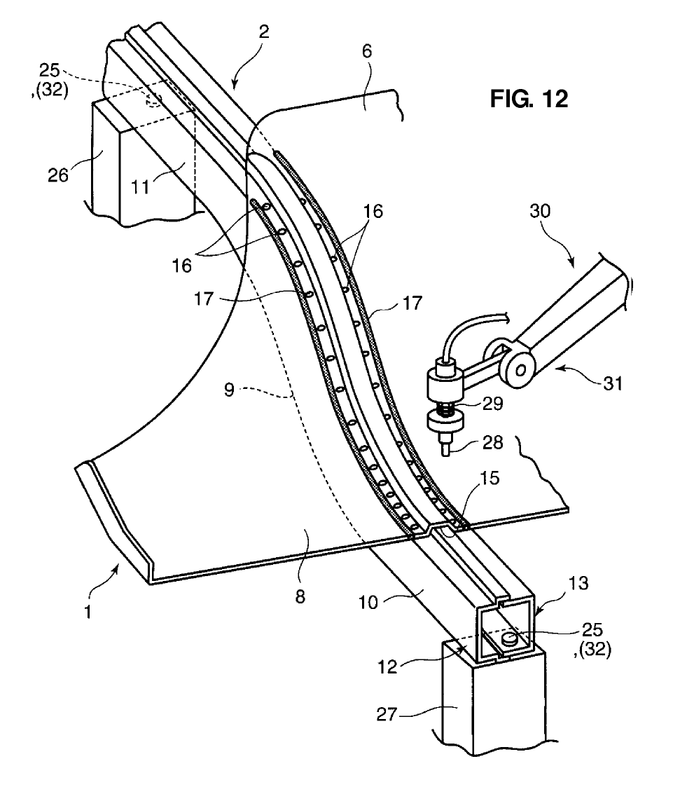

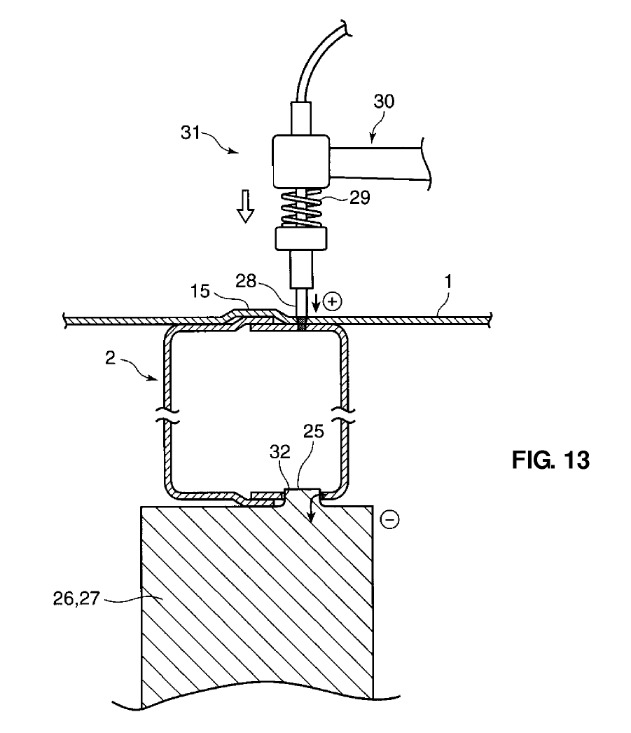

A second embodiment of the present invention is shown in FIGS. 12 and 13. According to the second embodiment, the temporary connection portion 17 is formed by connecting the vehicle-body panel of the front side frame 2 and the vehicle-body panel of the dash panel 1 with a spot welding using a one-side spot-welding device 31. This one-side spot-welding device 31 comprises a pair of ground jigs 26, 27 which have electrode projections 25 thereon, and a spot gun 30 which is equipped with a spot electrode 28 and a coil spring 29 which applies a specified pressing pressure to the spot electrode 28.

Herein, the front side frame 2 is placed on the pair of ground jigs 26, 27 in such a manner that the electrode projections 25 of the ground jigs 26, 27 are inserted into ground holes 32 which formed at the bottom of the front side frame 2. Thus, the front side frame 2 is supported in its positioning state. Herein, a coating film which covers the peripheral face of the ground holes 32 may be removed at need. Then, in a state in which the front side frame 2 and the ground jigs 26, 27 are coupled eclectically by making the electrode projections contact the peripheral face of the ground holes 32, the spot electrode 28 of the one-side spot-welding device 30 is pressed against the specified portion of the dash panel 1 along and beside the concave portion 15 to supply the electricity. Thereby, the temporary connection portion 16 which connects the vehicle-body panel of the front side frame 2 and the vehicle-body panel of the dash panel 1 with the spot welding is formed so as to have plural welding points at regular intervals.

The present invention should not be limited to the above-described embodiments, and any other modifications and improvements may be applied within the scope of a sprit of the present invention.

What is claimed is:

1. A vehicle body structure, comprising:
a flangeless hollow vehicle-body frame which has a rectangular closed cross section;
a vehicle-body panel welded to said vehicle-body frame;
a temporary connection portion temporarily connecting a face of said vehicle-body frame to said vehicle-body panel, the temporary connection portion comprising a plural connection points which is arranged along a longitudinal direction of the vehicle-body frame; and
a lazar welding portion connecting the face of said vehicle-body frame to said vehicle-body panel with a lazar welding, the lazar welding portion comprising a pair of continuous welding rows which is arranged at separate points located near both-side ends of the face of the vehicle-body frame.

2. The vehicle body structure of claim 1, wherein said vehicle-body panel has a concave portion at a central portion thereof between said separate points of the lazar welding portion, the concave portion being concaved toward one side which is opposite to a disposition side of said vehicle-body frame and extending in the longitudinal direction of the vehicle-body frame, and said temporary connection portion is arranged beside said concave portion of the vehicle-body panel.

3. The vehicle body structure of claim 2, wherein said vehicle-body frame comprises first and second members which have a U-shaped cross section and are connected to each other via a connection end portion thereof, a specified face of the vehicle-body frame which contains one of the connection end portions of the first and second members constitutes said face of the vehicle-body frame to be connected to the vehicle-body panel, and said concave portion of the vehicle-body panel has a size of width which corresponds to said connection end portion of the first and second members.

4. The vehicle body structure of claim 2, wherein said temporary connection portion is arranged at both sides of said concave portion.

5. The vehicle body structure of claim 3, wherein said first and second members form a front side frame of the vehicle-body frame which extends in a curve shape when viewed from the side of a vehicle.

6. The vehicle body structure of claim 2, wherein said temporary connection portion is formed by an ark welding which connects the vehicle-body frame to the vehicle-body panel via small through holes formed at the vehicle-body panel.

7. The vehicle body structure of claim 2, wherein said temporary connection portion is formed by a one-side spot welding which is applied from one side of the vehicle-body panel.

8. The vehicle body structure of claim 2, wherein said concave portion of the vehicle-body panel has a cross section which is of a trapezoid shape.

9. The vehicle body structure of claim 1, wherein said temporary connection portion is formed by an ark welding which connects the vehicle-body frame to the vehicle-body panel via small through holes formed at the vehicle-body panel.

10. The vehicle body structure of claim 9, wherein said small through holes are arranged zigzag along the longitudinal direction of the vehicle-body frame.

11. The vehicle body structure of claim 9, wherein said vehicle-body panel is a dash upper panel which is provided at a rear end portion of an engine room, and said vehicle-body frame is a dash cross member which is provided along the dash upper panel so as to extend in a vehicle width direction.

12. A manufacturing method of a vehicle body which includes a flangeless hollow vehicle-body frame which has a rectangular closed cross section and a vehicle-body panel which is welded to the vehicle-body frame, comprising:
a step of forming plural small through holes at a welded portion of the vehicle-body panel to the vehicle-body frame along a longitudinal direction of the vehicle-body frame;
a step of temporarily connecting the vehicle-body frame to the vehicle-body panel via the small through holes; and
a step of connecting the vehicle-body frame to said vehicle-body panel with a lazar welding which is applied to a specified portion along the small through holes formed in said small-through-hole forming step.
